(19) United States
(12) Patent Application Publication
(10) Pub. No.: US 2015/0272198 A1
(43) Pub. Date: Oct. 1, 2015

(54) USE OF IODINE-CONTAINING COMPOSITIONS FOR PATHOGEN REDUCTION DURING FOOD PROCESSING

(71) Applicant: DELAVAL HOLDING AB, Tumba (SE)

(72) Inventors: Carolina Mateus, Kansas City, MO (US); Tom List, Kearney, MO (US); Reed Semenza, Copperopolis, CA (US)

(73) Assignee: Delaval Holding AB a corporation

(21) Appl. No.: 14/433,126

(22) PCT Filed: Oct. 4, 2013
(86) PCT No.: PCT/SE2013/051171

§ 371 Date: Apr. 2, 2015

Related U.S. Application Data
(60) Provisional application No. 61/710,434, filed on Oct. 5, 2012.

(51) Int. Cl. A23L 3/358; A23B 7/157; A23B 4/24

(52) U.S. Cl. CPC A23L 3/358; A23B 4/24; A23B 7/157; A23V 2002/00

(57) ABSTRACT

Antimicrobial compositions and methods of using the same for controlling microbial contamination on various foodstuff's during processing are provided. The antimicrobial composition includes a relatively low concentration of active iodine as the antimicrobial agent, but achieves a high efficacy when applied directly to the foodstuff being processed. The present invention can be carried out during processing of meat, poultry, fish, seafood, and even produce with little or no reduction in quality of the final edible product.

### BACKGROUND

1. Technical Field

One or more embodiments of the present invention generally relate to the field of pathogen reduction during the processing of foodstuffs. More particularly, embodiments of the present invention relate to methods of reducing microbial contamination of animal- and plant-based materials being processed to provide edible food products.

2. Description of Related Art

Control of microbial contamination is a primary concern of the food processing industry. Bound both by stringent regulatory requirements and consumer demands, facility operators have long searched for effective methods of reducing or eliminating harmful and undesirable microorganisms, such as Escherichia coli, Salmonella, and Listeria monocytogenes, without adversely affecting the quality of the final product. One method for controlling microbial contamination of food during processing includes contacting the surface of the food with water or chemical washes to reduce microbial content and/or prevent microbial growth. While more effective than water washes at controlling contamination, most chemical washes are formulated to include harsh antimicrobial agents, such as acid and ammonia-based compounds, which can degrade the quality of the food being treated. In addition, many of the chemical wash formulations require on-the-spot mixing, which, along with the operational safeguards required for working with such materials, increases capital and operating costs for the processing facility.

Thus, a need exists for an effective, yet economical, method of controlling microbial growth on food during processing. The method should be widely applicable to a variety of food processing applications and should employ only safe, yet effective, antimicrobial compositions that will not adversely impact the quality of the final product.

### SUMMARY

One embodiment of the present invention concerns a method of treating a foodstuff so as to prevent or reduce the level of microbial contamination thereof. The method comprises the steps of (a) providing a foodstuff; (b) treating the foodstuff provided in step (a) with an antimicrobial composition having an iodine content in the range of from about 1 to about 50 parts per million by weight (ppmw) based on the total weight of the composition; and (c) processing at least a portion of the foodstuff treated in step (b) to provide at least one edible food product.

Another embodiment of the present invention concerns a method for preventing or reducing the level of microbial contamination of meat during processing. The method comprises the steps of (a) providing at least a portion of an animal carcass; (b) applying an iodine-containing antimicrobial composition to the animal carcass to thereby provide a treated carcass portion, wherein the iodine is the primary active biocidal agent of the antimicrobial composition; and (c) processing at least a portion of the treated carcass portion to thereby provide at least one edible meat product.

Yet another embodiment of the present invention concerns a method for preventing or reducing the level of microbial contamination of produce during processing. The method comprises the following steps: (a) providing one or more produce items to be processed; (b) transporting the produce items to a processing zone; (c) during at least a portion of the transporting of step (b), contacting the produce items with an iodine-containing antimicrobial flume and/or spray having an iodine content in the range of from about 1 to about 50 parts per million by weight (ppmw) to thereby provide one or more treated produce items; and (d) processing at least a portion of the treated produce items to thereby provide at least one edible produce item.

### BRIEF DESCRIPTION OF THE DRAWINGS

Various embodiments of the present invention are described in detail below with reference to the attached Figures, wherein:

FIG. 1 a graph comparing the efficacy of three different antimicrobial compositions against E. coli on beef as tested in Example 4;

FIG. 2 is a graph comparing the efficacy of three different antimicrobial compositions against E. coli on chicken as tested in Example 5; and

FIG. 3 is a graph comparing the efficacy of three different antimicrobial compositions against Salmonella on chicken as tested in Example 5.

### DETAILED DESCRIPTION

Methods and compositions for controlling microbial contamination of foodstuffs during processing are provided. According to one embodiment, the treatment of a foodstuff with an iodine-containing antimicrobial composition can be effective to substantially reduce the levels of and/or prevent the growth of certain microorganisms (e.g., bacteria, fungi, etc.) on the food surface, while preserving the taste, texture, smell, and color of the final edible product. The present invention is applicable to the processing of a wide variety of foodstuffs, including meat, poultry, fish, seafood, and produce, and can be easily and economically implemented into existing food processing facilities. Various embodiments of the present invention will be described in detail below.

In one embodiment, the first step of the inventive method is to provide a foodstuff for processing. As used herein, the term “foodstuff” refers to any food item or precursor to food item which can ultimately be made into an edible food product. According to one embodiment, the foodstuff can comprise at least a portion of a slaughtered animal. Animals suitable for processing can include, but are not limited to, cattle, pigs, sheep, goats, chickens, turkey, ducks, game foul, deer, bison, fish, and other animals. In some embodiments of the present invention, the foodstuff can be selected from the group consisting of beef, pork, mutton, goat meat, venison, bison, and poultry; while, in other embodiments, the foodstuff can be fish and/or seafood. As used herein, the term “poultry” is intended to encompass chicken, turkey, ducks, game foul, and bird species, while the term “seafood” refers to a wide class of aquatic food animals, such as fish, crabs, lobsters, mussels, and scallops. In still other embodiments of the present invention, the foodstuff can include one or more types of fruits and vegetables.

In some embodiments, the foodstuff provided for treatment can be a whole animal carcass, while, in other embodiments, the foodstuff can be a partial animal carcass that has previously undergone some treatment or processing. Examples of such prior treatment or processing include stunning, bleeding, dehairing, dehiding, defeathering, scalding, washing, drying, antimicrobial treatments, removal of head or feet, evisceration, and combinations thereof. When the foodstuff being treated includes produce, the foodstuff provided can have undergone one or more previous processing steps, such as, for example, sorting, picking, cutting, coring, peeling, cooking, steaming, and combinations thereof. In another embodiment, when the foodstuff provided is a previously processed or prepared food item, such as a cut of meat or chopped vegetables or fruits, the step of preparing or processing the foodstuff to be provided for treatment can include dicing, cutting, chopping, grinding, trimming, cooking, stuffing or encasing, and combinations thereof.

Once the foodstuff has been provided for treatment, it can be contacted with one or more antimicrobial compositions to reduce, eliminate, and/or prevent the growth of bacteria and other microorganisms. As used herein, the term “antimicrobial” refers to a substance capable of killing or inhibiting the growth of one or more types of microorganisms. When the antimicrobial composition is formulated to reduce pathogenic microbes to levels considered safe by public health codes or regulations, the composition is a “sanitizing” or “sanitization” solution. When the antimicrobial composition is formulated to destroy or irreversibly inactivate microorganisms, but not necessarily their spores, and prevent them from growing, the composition is a “disinfectant” or “disinfecting” solution. When the composition can be formulated to kill all microorganisms present, including spores, it can be referred to as a “sterilizing” or “sterilization” solution. Antimicrobial compositions as described herein can include sanitizing and disinfecting characteristics. According to one embodiment of the present invention, the antimicrobial composition employed during treatment can be effective to reduce the microbial levels of the foodstuff being treated by at least about 1 log, at least 2 log, or at least about 3 log, while maintaining the quality of the final edible product. Even if the foodstuff being processed includes little or no initial microbial contamination, treatments according to embodiments of the present invention can minimize or prevent growth of microorganisms, such as Salmonella, E. coli, and Lysteria, during subsequent processing of the foodstuff.

The antimicrobial compositions described herein can first be prepared as a concentrate before being diluted to form a final use antimicrobial composition suitable for application to the foodstuff, although, in some embodiments, it may be desirable to apply the concentrate directly to the foodstuff. When employed as a concentrate, the composition can comprise iodine in the range of from about 0.5 to about 60 weight percent, about 1 to about 30 weight percent, about 2 to about 28 weight percent, or about 3 to about 25 weight percent, based on the total composition. When employed as a diluted end use formulation, suitable diluents can include, but are not limited to, water, alcohols, or other non-toxic and carriers, preferably those approved for human consumption and can be present in the composition in an amount suitable to achieve a desired iodine content. In one embodiment, the final use solution can have an iodine concentration or content in the range of from about 1 part per million by weight (ppmw) to about 50 ppmw, about 2 ppmw to about 35 ppmw, about 5 ppmw to about 25 ppmw or is less than about 50 ppmw, less than about 40 ppmw, less than about 30 ppmw, less than about 25 ppmw, or less than about 20 ppmw, based on the total weight of the composition. The final use solution can have a concentrate to diluent weight ratio in the range of from about 1:700 to about 1:45,000, about 1:1000 to about 1:10,000, or about 1:1500 to about 1:6500.

Antimicrobial compositions as described herein include at least one source of iodine. In some embodiments of the present invention, iodine is the primary or sole active biocidal agent of the antimicrobial composition, although it is also within the scope of the present invention for the antimicrobial composition to comprise a mixture of antimicrobial agents. In some embodiments, the antimicrobial composition does not include any additional biocidal agents and is substantially free of components such as carboxylic acids including peracetic acid, peroxyoctanoic acid, germicidal fatty acids, and lactic acid; nitrogen-containing compounds, such as chloramines or ammonia; and other germicidal agents including, for example, ozone or EDTA.

According to one embodiment, the antimicrobial composition can include one or more solubilizing agents for complexing the iodine to form stable compositions having desirable iodine content. The solubilizing agent can comprise at least one of iodide ions, halogen ions, and other complexing agents such as alcohols, polyols, and surfactants, polyvinyl pyrrolidone, and combinations thereof. In one embodiment, the antimicrobial composition can include an iodide solubilizing agent derived from alkali metal iodides, such as NaI or KI, or hydriodic acid. In the same or other embodiments, the solubilizing agent can be a solubilizing halide ion, such as chlorine or bromine, derived from an alkali earth metal compound such as NaBr and/or NaCl, or acids such as HBr, and/or HCl.

In another embodiment, iodine can be complexed with a solubilizing agent selected from the group consisting of oxygen-containing organic compounds such as alcohols, diols, polyols, and non-ionic surfactants. Examples of suitable solubilizing or complexing agents can include, but are not limited to, alkylphenol ethoxylates, alcohol ethoxylates, alcohol alkoxylates, polyalkylene glycol ethers, polyoxyethylene sorbitan monolaurate and monopalmitate, polyvinylpyrrolidone, polyethoxylated polyoxypropylenes, and mixtures thereof. In one embodiment, the complexing agent can comprise at least one of nonylphenol ethoxylates, alcohol ethoxylates, polyvinylpyrrolidone, and glycerin. In the same or other embodiments, the complexing agent may be a non-ionic surfactant having the general formula:

R(CHR′—CHR′—O)ₙ—H

wherein R represents the residue of an organic compound containing an active hydrogen or hydroxide and R′ represents hydrogen of a C₂-C₄ alkyl group and n is an integer ranging from 3 to 212. Exemplary non-ionic surfactants of this type include those from the PLURONIC family (commercially available from BASF), especially those with a molecular weight of at least about 1,000 grams per mole (g/mol), at least about 1,500 g/mol, or at least about 2,000 g/mol.

In one embodiment, the iodine solubilizing agent can be present in the antimicrobial composition in an amount in the range of from about 0.15 to about 30 weight percent, about 1 to about 20 weight percent, about 2 to about 15 weight percent, or about 5 to about 10 weight percent, based on the total weight of the concentrate. In another embodiment, one or more of the solubilizing agents listed above can be present in an amount of from about 20 to about 70 weight percent, about 25 to about 60 weight percent, or about 35 to about 55 weight percent, based on the total weight of the concentrate. According to one embodiment, the antimicrobial composition can include at least one of glycerin, at least one non-ionic surfactant, and a solubilizing halide ion.

The antimicrobial compositions described herein have a suitable shelf-life or stability over time. In one embodiment, antimicrobial compositions utilized by the present invention can be stable for a period of at least about 3 months, at least about 6 months, at least about 9 months, or at least about 1 year at room temperature (i.e., about 25° C.). As used herein, the term “stable” means that the concentrates remain as substantially single phase, homogenous solutions throughout a given storage period at room temperature and at least about 90 percent of the starting iodine concentration remains. In one embodiment, the iodine concentration of the antimicrobial composition after such a storage period can be in the range of from about 0.00005 weight percent to about 0.5 weight percent, about 0.0001 weight percent to about 0.05 weight percent, or about 0.0005 weight percent to about 0.005 weight percent, based on the total final use composition.

The antimicrobial composition may also include one or more other types of additives to impart various desirable properties to the final use composition. In one embodiment, the composition can include one or more dispersants to enhance the coverage of the antimicrobial composition once applied. Examples of suitable dispersants include those surfactants listed above. In some embodiments, particularly when the dispersant comprises a surfactant, a portion of the dispersant can function to complex/solubilize at least a portion of the iodine. Other suitable additives include buffering agents, wetting agents, thickening agents, or hydrotropes. Specific species suitable for use as each of these types of additives are provided in U.S. Pat. No. 5,885,620, the disclosure of which is incorporated herein by reference in its entirety. However, in other embodiments, the antimicrobial compositions described herein can be formulated in the absence of these additives such that the final composition is substantially free of one or more of buffering agent, wetting agents, thickening agents, and/or hydrotropes.

In general, the antimicrobial composition can be applied to the foodstuff being processed in any suitable manner. For example, in one embodiment, the delivery method for applying the antimicrobial composition can comprise one or more of spraying, dipping, immersing, fogging, and/or steaming. The specific type of treatment, as well as the conditions of application (e.g., temperature, pressure, and duration) can depend on the specific foodstuff being processed, as well as the desired microbial load reduction.

When the delivery method for the antimicrobial composition includes spraying, the temperature of the antimicrobial composition upon initial application to the foodstuff can be approximately ambient or can be slightly warmer or cooler. In one embodiment, the temperature of the antimicrobial composition during a spray application can be in the range of from about 0° C. to about 50° C., about 5° C. to about 45° C., or about 10° C. to about 35° C. The spray can be applied intermittently or continuously for an overall duration in the range of from about 1 second to about 5 minutes, about 2 seconds to about 2 minutes, or about 5 seconds to about 1 minute. in the range of from about 1 second to about 1 minute, about 2 seconds to about 45 seconds, or about 5 seconds to about 30 seconds.

In some embodiments, the antimicrobial compositions described herein can be contacted with at least about 75 percent, at least about 85 percent, at least about 90 percent, or at least about 95 percent of the total surface area of the foodstuff for at least about 2 seconds, at least about 3 seconds, at least about 5 seconds, or at least about 10 seconds. At the same time, however, the amount of weight gained by the foodstuff during a spray application can be substantially lower than those experienced with conventional washes. For example, in some embodiments, the amount of weight gained by the foodstuff being treated by spray, fog, or steam application with the antimicrobial compositions herein can be less than about 0.049 weight percent, while still achieving the microbial reduction discussed previously.

According to other embodiments of the present invention, the foodstuff can be at least partially immersed in one or more liquid baths containing the antimicrobial composition. When treated via immersion, the temperature of the antimicrobial composition can be approximately ambient or can be heated or cooled slightly. In some embodiments, the immersion baths can be chiller baths having a temperature in the range of from about 4° C. to about 25° C., about 4° C. to about 20° C., or about 8° C. to about 15° C. The contacting time for this type of application can be in the range of from about 1 second to about 4 hours, about 1 minute to about 2 hours, or about 5 minutes to about 30 minutes, depending on the foodstuff being processed, the strength of the composition being used, and the desired efficacy. Although the immersion baths are typically static, in some embodiments, foodstuffs submerged or immersed in water may simultaneously be transported from one location within the facility to another, such as, for example flume water transport systems used in produce processing.

The antimicrobial compositions described herein can be applied in a single application or, more preferably, as a series of consecutive applications. In one embodiment, when applied via two or more separate application stages, the antimicrobial composition can be applied at different times in the process such that one or more food processing steps (e.g., cutting, chopping, etc.) can be carried out between the applications. In another embodiment when the antimicrobial composition is applied in two or more separate application stages, each application can be applied simultaneously in consecutive treatments conducted at approximately the same stage of the process. The time between subsequent applications can be about 5 seconds to about 4 hours, about 10 seconds to about 1 hour, or about 30 seconds to about 30 minutes. In some embodiments, when the antimicrobial composition is applied via two or more separate stages, each stage can be conducted at approximately the same temperature, pressure, and/or for the same duration, while, in other embodiments, at least one of the temperature, pressure, and duration of treatment can be different. Further, the delivery methods of serial applications can be of the same type (e.g., consecutive sprays) or can be different types (e.g., a spray followed by an immersion bath). Exemplary embodiments of specific processing configurations will be described in detail shortly.

Once treated, the foodstuff can then be further processed. Depending on the specific foodstuff, this additional processing can include at least one of dicing, cutting, chopping, grinding, trimming, cooking, stuffing or encasing, and combinations thereof and/or coring, peeling, cooking, steaming, and combinations thereof. For example, when the treated foodstuff comprises a cut of beef, the further processing can include grinding or trimming the meat to produce ground beef and/or prime cuts. Optionally, once processed, one or more additional antimicrobial treatments can be applied to the processed foodstuffs (e.g., the ground beef or prime cuts) using one or more methods and/or compositions as described above. When the foodstuff comprises produce, the processing can include cutting or chopping and the resulting processed food items can be contacted with an antimicrobial composition as discussed above before being packaged or otherwise used.

The foodstuffs treated according to the present invention can then be provided as an edible food product. Advantageously, food products treated in accordance with the present invention do not exhibit any negative organoleptic properties, including taste, color, smell, and texture, as detectable by the unaided human senses. Thus, in certain embodiments, it is intended that treated food products exhibit similar organoleptic properties as untreated food products, and are practically indistinguishable therefrom, with the exception of having reduced microbial levels. In addition, when directly contacted with the foodstuff being processed, the antimicrobial compositions described herein do not have a lasting effect on the foodstuff. Accordingly, foodstuffs processed as described herein exhibit substantially lower levels of microbial contamination while maintaining regulatory requirements and providing a high quality final product.

### Beef Processing

According to one exemplary embodiment of the present invention, an iodine-containing antimicrobial composition as described above can be applied to beef at various stages within a beef processing facility. Once the cattle have been slaughtered and have undergone a preliminary wash, the carcass is dehided to expose the meat. Thereafter, the exposed meat can be treated with one or more sequential applications of the antimicrobial composition discharged from medium- to high-pressure spray nozzles aimed to contact the inside and outside of the carcass at a pressure of between 15 and 50 psig. Each application can have a duration of between about 5 to about 15 seconds and can optionally include hot water rinses occurring in the interim between antimicrobial composition applications. The resulting carcass can exhibit a reduction in microbial load of between about 0.5 to about 2 log without signs of adverse organoleptic effects. Subsequently, the treated carcass can be cut into portions, which can be routed to various areas of the facility for conversion into prime cuts, trim, organs, and ground meat. In one embodiment, one or more antimicrobial treatments can be applied during these processing steps to reduce or minimize microbial contamination of the final beef product. After being packaged or otherwise prepared for storage, the beef products can be cooled, stored, and/or shipped to customers or final end users. Beef products produced as described herein exhibit no adverse taste, color, smell, or texture resulting from the antimicrobial composition treatments and have substantially lower levels of microbial contamination.

### Poultry Processing

In one exemplary embodiment of poultry processing according to the present invention, the poultry is slaughtered and the carcasses are washed, defeathered, and eviscerated. Thereafter, the resulting poultry foodstuff can be washed in a series of antimicrobial treatments utilizing an iodine-containing composition as described herein. The antimicrobial treatments can include a whole carcass spray wash followed by submersion in a series of antimicrobial chiller baths. In one embodiment, the whole carcass spray can be carried out at a pressure of between about 20 psig and about 150 psig for a duration of between about 2 to about 30 seconds per carcass. In one embodiment, the resulting treated carcass can then optionally be split into upper and lower segments before being sent to sequential chiller baths, which can number between 2 and 6. The chiller baths can have a temperature of between about 4° C. to about 10° C., and the carcasses can have a dwell time in each bath of between about 5 minutes to about 4 hours. Thereafter, the treated carcass or carcass portions can be removed from the bath and can be further processed and/or treated to provide the final poultry product. Poultry treated according to embodiments of the present invention exhibits no discoloration or adverse odor or taste. In addition, poultry treated as described herein exhibits minimal loss of water during processing, thereby increasing marginal value of the products produced.

### Produce Processing

In yet another embodiment of the present invention, one or more antimicrobial compositions as described herein may be used to treat various types of fruits and/or vegetables in a produce processing facility. For example, in one embodiment, fruits and vegetables may be provided for processing via delivery to an unloading zone of a processing facility. The produce may be delivered as fresh produce, pre-chilled or refrigerated produce, or combinations thereof.

Once unloaded from the truck, the produce items may be loaded into a flume water transport system for moving the fruits and/or vegetables from the unloading zone to a downstream processing zone. If the produce is refrigerated, the fruit and/or vegetable items may be loaded into a primary flume, which both rinses and transports the produce passing therein. If the produce is fresh, a three-flume transport system may be employed with a primary flume moving the produce into the processing plant and a secondary, or transportation, flume moving the produce onto a conveyor. From the conveyor, the treated produce can then be moved to a tertiary, or rinsing, flume and can thereafter be reloaded onto a conveyor belt for moving the rinsed produced to the processing zone. In the processing zone, the produce items can be further processed and may be, for example, chopped, sliced, steamed, mixed, juiced, peeled, mashed, sorted, or combinations thereof. The resulting produce product may then be packaged for further storage, transport, or sale.

In one embodiment, at least one of the flumes used to transport produce may have an iodine content in the range of from about 0.5 to about 20 ppmw, at least about 1 to about 10 ppmw, or at least about 2 to about 8 ppmw. Such concentrations of iodine may be obtained utilizing an antimicrobial composition according to one or more embodiments described herein. The produce typically remains in each flume, including the iodine-containing flume, for a contact time in the range of from about 15 seconds to about 15 minutes. The temperature of the water during flume transport may be in the range of from about 40° F. to about 95° F., about 50° F. to about 90° F., or about 60° F. to about 85° F. Typically, when processing fresh produce, the iodine-containing flume can be the tertiary flume and it may have an iodine content within the ranges described above. In some embodiments, the multi-flume transport system may be a cascade system, such that the water from the tertiary flume is recycled to the secondary flume and the secondary flume water is reused in the primary flume. In this case, the secondary and/or primary flumes may also have at least trace amounts of iodine as well.

Additionally, the produce items may be treated with one or more antimicrobial washes during at least a portion of its transporting between the unloading zone and the processing zone. When processing fresh produce, the antimicrobial wash may be applied on the first conveyor, as the produce passes between the secondary and tertiary flumes. During processing of refrigerated produce, the produce items may be contacted with an antimicrobial wash once removed from the single transport/rinse flume, but prior to being processed as described above. Optionally, one or more of the produce items may also be treated with an antimicrobial wash after processing, but prior to packaging. The antimicrobial wash can be formulated as described herein and may have an iodine content in the range of from about 5 to about 60 ppmw, about 10 to about 50 ppmw, or about 15 to about 45 ppmw. Typically, the temperature of the antimicrobial wash or spray when applied to the produce can be in the range of from about 35° F. to about 75° F., about 40° F. to about 70° F., or about 45° F. to about 65° F. and may be applied by any known device, such as, for example, a spray bar. The contact time of the antimicrobial spray can vary from about 15 seconds to about 10 minutes, about 20 seconds to about 8 minutes, or about 30 seconds to about 5 minutes and may be applied in at least 1, at least 2, or at least 3 separate applications.

The various aspects of the present invention can be further illustrated and described by the following Examples. It should be understood, however, that these Examples are included merely for purposes of illustration and are not intended to limit the scope of the invention, unless otherwise specifically indicated.

### EXAMPLES

In Example 1, several antimicrobial compositions including varying iodine contents were prepared. In Examples 2 and 3, below, beef and chicken were treated with several of the compositions prepared in Example 1, and the impact of the treatment on the organoleptic properties of the meat was studied. In Examples 4 and 5, the efficacy of several compositions prepared in Example 1 against E. coli and Salmonella on beef and chicken was determined and the results were compared to those of meats treated with a commercially available antimicrobial solution including peracetic acid as the active ingredient. Examples 6 and 7 describe the efficacy of inventive antimicrobial solutions for treating produce via spray and submersion techniques, while Prophetic Example 8 is included to provide details regarding several antimicrobial compositions that have been contemplated. As shown in the Examples below, use of lower levels of an antimicrobial agent in compositions as described herein can minimize or prevent adverse organoleptic effects without a reduction in efficacy.

### Example 1

### Preparation of Several Antimicrobial Compositions

Table 1, below, summarizes the composition of an exemplary antimicrobial concentrate suitable for use in the present invention. Preparation of the concentrate is described below.

TABLE 1
Composition of Antimicrobial Concentrate

| Component | Amount, wt % |
|---|---|
| Tap Water | 65.76 |
| PLURONIC P-105 surfactant* | 9.38 |
| Sodium Chloride | 1.85 |
| Iodine, Crude Reaction Grade | 4.05 |
| Sodium Iodide (57%) | 0.17 |
| Phosphoric Acid (75%) | 9.30 |
| Sulfuric Acid (93%, 66° Be) | 9.49 |

*ethylene oxide-propylene oxide block copolymer nonionic surfactant

Approximately 90 percent of the total amount of tap water was pumped into a mixing tank. The tank heater was adjusted to maintain the temperature of the mixture between 48° C. and 55° C. An agitator in the tank was turned on and the contents of the tank were mixed at a moderate speed. No recirculation pumps were used. Next, the PLURONIC P-105 surfactant (commercially available from BASF) was added to the mixture, which was allowed to agitate until a solution was formed. Next, the scrubber was turned on and the sodium chloride was added to the mixture. The temperature of the solution was maintained between 48° C. and 55° C. and, if the temperature of the mixture exceeded 45° C., the solution was allowed to cool before proceeding.

Next, the sodium iodide (57%) was added to the tank along with the remainder of the tap water, which had a temperature between 10° C. and 26° C. The contents of the tank were then allowed to stir for approximately 90 minutes, while the temperature inside the tank was maintained at less than 45° C. If the temperature of the mixture exceeded 45° C., the solution was allowed to cool before proceeding.

Next, iodine was added to the solution as reaction grade, although a similar amount of non-reaction grade iodine would have been equally suitable. The solution was vigorously agitated with the flow direction toward the bottom of the tank. A recirculation pump was sporadically used in addition to the heater to maintain the temperature. After the solution was well mixed, the scrubber was turned off and the tank was sealed to maintain the temperature of the solution between 45° C. and 50° C. while it was agitated. After about 2 hours, the phosphoric acid FG (75%) and sulfuric acid (93%, 66° Be) were added to the solution. The resulting solution was quality checked, approved, and then filtered via passage through a 25-50 micron filter.

Once filtered, several aliquots of the resulting concentrate were diluted to obtain seven antimicrobial compositions (Compositions 1-7), each having a different iodine content. For example, Composition 1 was diluted to an iodine content of 25 ppm by weight by combining 1 fluid ounce of the antimicrobial concentrate described above with 13 gallons of water. Similarly, Compositions 2-7 were formulated by adding 1 fluid ounce of antimicrobial concentrate to a certain amount of water in order to provide antimicrobial compositions of varying iodine concentration. Table 2, below, summarizes the iodine contents, volume of water required, and dilution ratios for each of antimicrobial Compositions 1-7, produced from the concentrate listed in Table 1.

TABLE 2
Iodine Content of Various Antimicrobial
Compositions from Concentrate in Table 1

| | Iodine | Gallons of Water per | |
|---|---|---|---|
| Composition | Content, ppm | 1 fl. oz. Concentrate | Dilution Ratio |
| 1 | 25 | 13 | 1:1700 |
| 2 | 12.5 | 26 | 1:3400 |
| 3 | 10 | 34 | 1:4400 |
| 4 | 7 | 49 | 1:6200 |
| 5 | 5 | 62 | 1:8300 |
| 6 | 1 | 325 | 1:41,600 |
| 7 | 50 | 6.5 | 1:850 |

The efficacy and effect on organoleptic properties for each of Compositions 1-6 were tested on beef and chicken, as described in detail in Examples 2-5, below.

### Example 2

### Effect of Antimicrobial Compositions on the Organoleptic Properties of Beef Samples

Several small samples of beef that included both lean muscle meat and fatty tissue were cut and completely submerged in separate baths of Compositions 1, 2, 4 and 6. The samples were allowed to soak for 1 minute at 30° C. Each of the beef pieces were then removed from the solutions and the samples were visually inspected. No adverse changes to the color, texture, or odor of any of the samples were observed. Accordingly, it was concluded that treatment with any of Compositions 1, 2, 4, or 6 resulted in no adverse organoleptic effects to the lean muscle meat or fat of the beef samples.

### Example 3

### Effect of Antimicrobial Composition on Organoleptic Properties of Poultry

Separate water baths including Compositions 1, 3, and 5 were cooled to a temperature between 4° C. and 5° C. Whole chicken carcasses, which had been defeathered, scalded, eviscerated (including removal of the head and feet), and pre-chilled, were placed in each of the baths and allowed to soak. A control chicken was placed in a chilled bath of pure water that did not include any antimicrobial composition. After 2 hours, the samples were removed from the baths and visually inspected. None of the samples produced a noticeable iodine odor and no discoloration was observed for either the control chicken or the chicken soaked in the solution of Composition 5 (5 ppm iodine). A very slight yellowing occurred at some of the feather follicles of the chicken treated with the Composition 3 (10 ppm iodine) and the chicken treated with Composition 1 (25 ppm iodine) exhibited yellow staining of the skin and feather follicles. However, no staining of the meat was observed for the latter two birds.

After visual inspection, each of the chickens was placed on ice to simulate cool storage after processing. After 2 hours, the chilled birds were removed and visually inspected. The chickens soaked in Compositions 5 (5 ppm iodine) and 3 (10 ppm iodine) did not show any discoloration or staining of the meat, but the feather follicles and skin of these birds exhibited minor yellow staining. The chicken exposed to Composition 1 (25 ppm iodine) exhibited extreme yellow staining of the skin and feather follicles, but showed no staining of the meat.

Each of the chickens were then cooked to an internal temperature of 160° F. and visually inspected. The chicken that had been exposed to Composition 1 (25 ppm iodine) had slightly darker skin, which was not observed in the specimen subjected to treatment with Compositions 3 (10 ppm) or 5 (5 ppm). Samples of the cooked birds were smelled and tasted and no unpleasant odor or flavor was observed.

### Example 4

### Efficacy of Various Antimicrobial Compositions against E. Coli on Beef

Three samples of beef weighing approximately 100 grams (±5 g) were cut from similar beef cuts. Each of the samples was inoculated with 1 ml of 10⁸ cfu/ml of E. coli ATCC 10536 and was allowed to marinate in the bacterial solution at a temperature of 4° C. After 2 hours, the samples were removed and excess E. coli solution was shaken off. Each of the samples was then sprayed with a biocidal solution for approximately 10 seconds, such that each sample was contacted with approximately 3 mL of liquid per 100 g of sample. One of the beef samples was sprayed with another antimicrobial treatment, DELASAN MP, commercially available from DeLaval Manufacturing, which included 100 ppm of peracetic acid as its active ingredient. The remaining two samples were treated with Compositions 1 (25 ppm iodine) and 2 (12.5 ppm iodine), respectively.

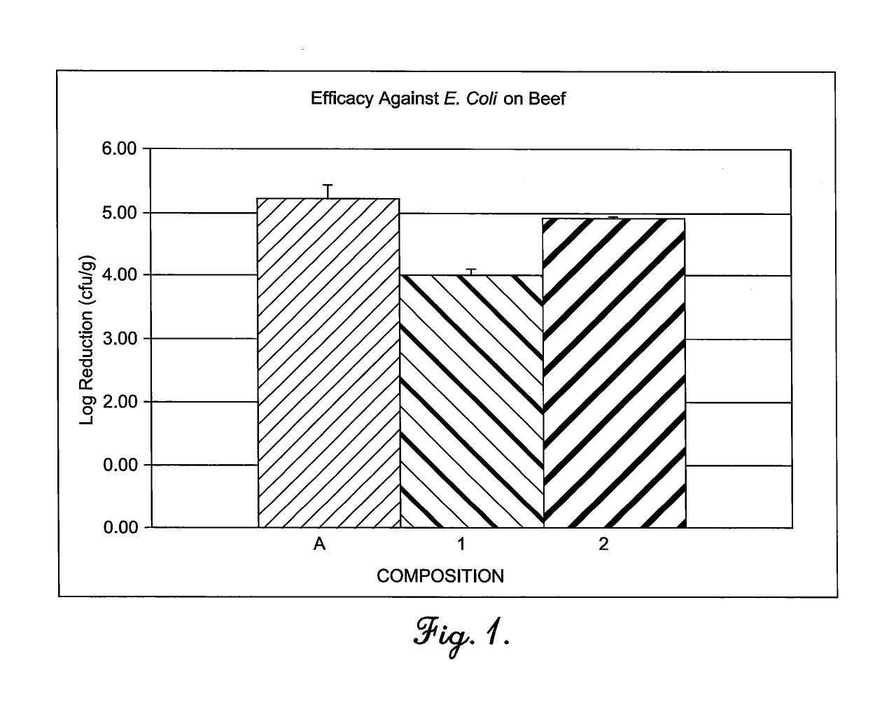

After spraying, the samples were placed in a neutralizer solution appropriate for the type of active biocidal agent. The sample treated with Composition A (100 ppm PAA) was placed in a Dey/Engley (D/E) neutralizing solution, while the samples treated with Compositions 1 (25 pm iodine) and 2 (12.5 ppm iodine) were neutralized with a peroxide solution. The neutralized samples were then removed and the concentration of bacteria recovered from the neutralizing solutions was determined using standard microbiological methods. As depicted graphically in FIG. 1, Composition A (100 ppm PAA) and Composition 2 (25 ppm iodine) exhibited comparable efficacies against E. coli on beef, while the efficacy achieved by Composition 1 (12.5 ppm iodine) was only about 1 log lower.

### Example 5

### Efficacy of Various Antimicrobial Compositions against Salmonella and E. Coli on Poultry

Skin-on chicken breasts were cut into several 100-gram portions. Half of the samples were allowed to marinate at room temperature in a bacterial solution of 10⁴ cfu/ml of E. coli ATCC 10536, while the other half were marinated at the same temperature in 10⁴ cfu/ml of Salmonella ATCC BAA-711. After 5 minutes, the samples were removed and placed on a metal wire rack for 5 minutes to allow the excess solution to drain from the meat.

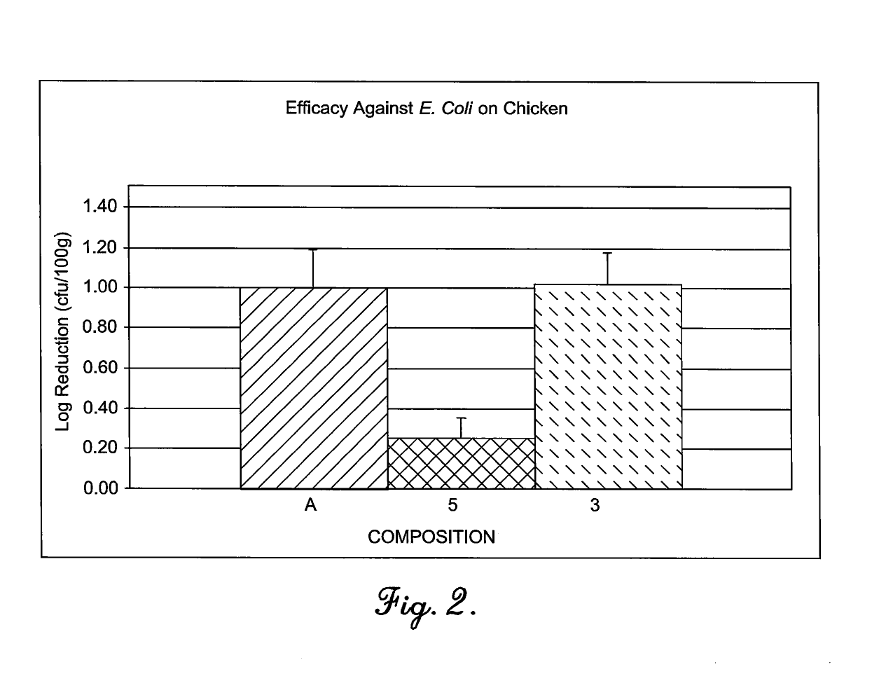

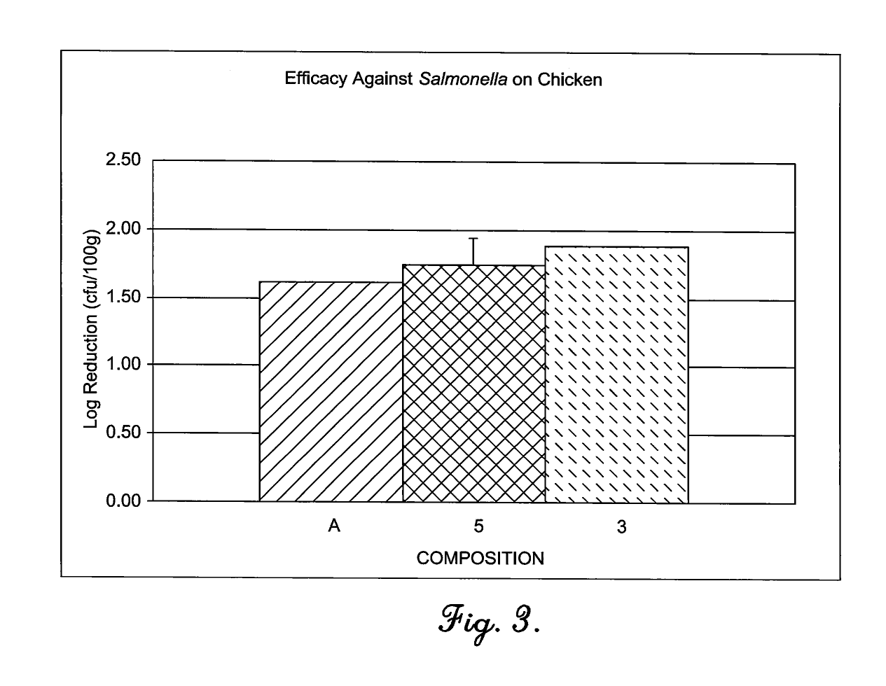

The inoculated samples were then submerged in 500 mL of various antimicrobial compositions at 40° F. A control sample was submerged in a sterile water bath and another sample was treated with Composition A (100 ppm PAA). Two other samples were treated in baths including Compositions 3 (10 ppm iodine) and 5 (5 ppm iodine). After 2 hours, the samples were removed from the respective baths and placed in 100 mL of an appropriate neutralizer solution. The samples were removed and the concentration of bacteria recovered from the neutralizing solutions was determined using standard microbiological methods. As depicted graphically in FIGS. 2 and 3, respectively, Composition A (100 ppm PAA) and Composition 3 (10 ppm iodine) were able to achieve similar efficacy against E. coli on chilled poultry, while both Compositions 3 (10 ppm iodine) and 5 (5 ppm iodine) achieved similar efficacy as Composition A (100 ppm PAA) against Salmonella on chilled poultry.

### Example 6

### Efficacy of a 50 ppm Iodine Antimicrobial Composition Against E. Coli on Produce

Multiple sets of whole and partial (cut) fruit and vegetable samples were prepared. The first sample set included 2 small onions and 3 green grapes, and the second set included 2 small onions, 3 green grapes, and 3 pieces of cut honey dew melon without rind. The components of each sample set were inoculated for 5 minutes with a 100 ml solution containing 1×10⁶ CFU/mL of E. coli. After 5 minutes, the produce was removed and allowed to air dry for 20 minutes.

The first sample set was sprayed with approximately 1 mL (e.g., approximately 5 pumps from a spray bottle) of Composition 7 (50 ppmw iodine) prepared in Example 1, above, for a total contact time of approximately 30 seconds. After the appropriate contact time had expired, the sprayed samples were placed in 10 mL of peroxide neutralizing solution and the solution was analyzed for microorganisms using the Most Probable Number (MPN) technique. The inoculum level and efficacy results, expressed as the logarithmic reduction (LR) versus the samples treated with water alone for the onions and grapes tested via spray application of Composition 7 are summarized in Table 3, below.

TABLE 3
Inoculum and Efficacy for Produce Treated via Spray

| | | | Maximum Efficacy for |
|---|---|---|---|
| Type of Produce | Inoculum, CFU/g | LR | Experiment |
| Onions | 1.88e+01 | 1.16 | 1.16 |
| Grapes | 8.44e+01 | 1.88 | 1.88 |

The samples of the remaining set were submerged in a tub containing 50 mL of Composition 7 (50 ppmw iodine) prepared above in Example 1. The total submersion time was 10 minutes. After 10 minutes, 1 mL of the antimicrobial composition was removed from the submersion tubs and added to a peroxide neutralizer solution. The neutralizer was analyzed for microorganisms recovered as described above. Inoculum level and efficacy (LR) results for the onions, grapes, and melon tested via submersion in antimicrobial Composition 7 are summarized in Table 4, below.

TABLE 4
Inoculum and Maximum Efficacy for
Produce Treated via Submersion

| Type of Produce | Inoculum, CFU/g | LR | Maximum Efficacy |
|---|---|---|---|
| Onions | 3.14e+02 | 1.02 | 1.02 |
| Grapes | 3.14e+02 | 1.02 | 1.02 |
| Melon | 3.23e+04 | 2.03 | 4.52 |

### Example 7

### Efficacy of Various Antimicrobial Compositions against E. Coli on Produce

Two additional sets of samples were prepared and inoculated as described in Example 6, above. A first sample set including grapes and melon pieces was prepared for submersion treatment, while a second sample set including onions and grapes was prepared for spray application treatment. Thereafter, the inoculated samples were either sprayed with or submerged in one of Composition 1 (25 ppmw iodine) and Composition 3 (10 ppmw iodine). The treated samples were neutralized in a peroxide solution and the efficacy of each application method for each Composition was calculated. The results are provided in Tables 5a and 5b, below.

TABLE 5a
Efficacy of Submersion Treatment of Various Types of Produce

| | Grapes | Melon |
|---|---|---|
| Composition | LR | LR |
| 3 | 1.02 | 0.59 |
| 1 | 1.02 | 2.24 |

TABLE 5b
Efficacy of Spray Treatment of Various Types of Produce

| | Onion | Grapes |
|---|---|---|
| Composition | LR | LR |
| 3 | 1.16 | 1.88 |
| 1 | 1.16 | 1.88 |

### Example 8

### Preparation of Other Antimicrobial Compositions

Two additional exemplary antimicrobial compositions (Compositions 8 and 9) are prepared in a similar manner as disclosed in Example 1, above. Table 6, below, summarizes the key components of each of Compositions 8 and 9.

TABLE 6
Additional Antimicrobial Concentrate Formulations

| Component | Composition 8 | Composition 9 |
|---|---|---|
| Purified Water | 2 wt % | 10.5 wt % |
| Aqueous Sodium Iodine | 50 wt % | — |
| Complex with 57 | | |
| wt % iodine and | | |
| 24.5 wt % sodium iodide | | |
| Glycerin | 48 wt % | 48 wt % |
| Iodine | — | 28.5 wt % |
| Sodium Chloride | — | 13 wt % |

Each of the concentrates listed in Table 6 above have an iodine content of 28.5 weight percent. Each are then diluted to include an iodine content in the range of 1 to 50 ppmw, according to the dilution ratios summarized in Table 7, below. The diluted solutions are then used as described herein to prevent or reduce microbial contamination of foodstuffs, including meat and produce, during processing.

TABLE 7
Dilution Required to Achieve Various Iodine
Contents Using Concentrates in Table 6

| Iodine | Gallons of Water per | |
|---|---|---|
| Content, ppm | 1 fl. oz. Concentrate | Dilution Ratio |
| 1 | 3800 | 1:490,000 |
| 5 | 760 | 1:97,000 |
| 25 | 153 | 1:19,500 |
| 50 | 76 | 1:9700 |

The embodiments of the invention described above are used as illustration only, and should not be used in a limiting sense to interpret the scope of the present invention.

### Example 9

### Efficacy of Antimicrobial Compositions on Poultry Treated Via Spray Application

In this Example, the antimicrobial efficacy on poultry of compositions according to the present invention was compared with two iodine-free treatments, specifically, treatments containing chlorine dioxide (3 ppm) and peracetic acid (50 ppm). Whole chicken carcasses, which had been defeathered, scalded, eviscerated (including removal of the head and feet), and pre-chilled, allowed to marinate at room temperature in 10⁴ cfu/ml of Salmonella ATCC BAA-711. After 5 minutes, the samples were removed and placed on a metal wire rack for 5 minutes to allow the excess solution to drain from the meat.

The antimicrobial compositions were applied by spraying through nozzles disposed so that the spray would contact the carcass outer surface. A first control chicken carcass was sprayed with pure water only and a second control carcass was left untreated. In a first set of trials, the bird carcasses were sprayed for 5 seconds at 4° C. and 30 psi. The iodine-containing treatment used was Composition 3 from Table 2 above, containing 10 ppm iodine. The peracetic acid solution used comprised a mixture of between 14.7-15.5% peroxyacetic acid, 4.5-5.8% hydrogen peroxide, and 30-40% acetic acid, available as DeLasan MP, which was diluted with water to give a peracetic acid level of 50 ppm. The chlorine dioxide solution comprised a 3000 ppm chlorine dioxide in water solution, available as Redi-Ox from DeLaval Manufacturing, that was diluted with water to a final chlorine dioxide concentration of 3 ppm. The treated carcasses were analyzed for aerobic plate count (APC) levels and Salmonella levels (vs. water only), and a log reduction value was calculated relative to the controls. The results are listed in Tables 8 and 9, below.

TABLE 8
Antimicrobial Efficacy of Treatments
vs. Water on Whole Bird Carcass

| | APC (cfu/ml) | Salmonella (cfu/ml) |
|---|---|---|
| Treatment | log reduction | log reduction |
| Iodine (10 ppm) | 0.83 | 0.38 |
| Peracetic acid (50 ppm) | 0.63 | 0.13 |
| Chlorine Dioxide (3 ppm) | 0.44 | 0.03 |

TABLE 9
Antimicrobial Efficacy of Treatments vs.
Untreated Control on Whole Bird Carcass

| | APC (cfu/ml) |
|---|---|
| Treatment | log reduction |
| Iodine (10 ppm) | 0.88 |
| Peracetic acid (50 ppm) | 0.63 |
| Chlorine Dioxide (3 ppm) | 0.53 |

In a second trial, the active concentrations and spray pressure and time were adjusted. Iodine-containing Compositions 1 and 7, 25 and 50 ppm iodine, respectively, from Table 2 above were used. The peracetic acid solution was tested at a peracetic acid level of 90 ppm, and the chlorine dioxide solution was tested at chlorine dioxide levels of 15 ppm and 30 ppm. A water-only spray was used as a control. The bird carcasses were sprayed with each solution for 15 seconds at 4° C. and 40 psi. The treated carcasses were analyzed for APC, only. The results are listed in Table 10, below.

TABLE 10
Antimicrobial Efficacy of Treatments
vs. Water on Whole Bird Carcass

| | APC (cfu/ml) |
|---|---|
| Treatment | log reduction |
| Iodine (25 ppm) | 0.81 |
| Iodine (50 ppm) | 0.77 |
| Peracetic acid (90 ppm) | 0.85 |
| Chlorine Dioxide (15 ppm) | 0.35 |
| Chlorine Dioxide (30 ppm) | 0.94 |

### Example 10

### Efficacy of Antimicrobial Compositions on Poultry Treated Via Immersion

In this Example, the antimicrobial efficacy on poultry of a composition according to the present invention (25 ppm iodine) was compared with two iodine-free treatments, specifically, treatments containing chlorine dioxide (30 ppm) and peracetic acid (25 and 90 ppm). Whole chicken carcasses, which had been defeathered, scalded, eviscerated (including removal of the head and feet), and pre-chilled, allowed to marinate at room temperature in 10⁴ cfu/ml of Salmonella ATCC BAA-711. After 5 minutes, the samples were removed and placed on a metal wire rack for 5 minutes to allow the excess solution to drain from the meat.

Separate water baths including Composition 1 from Table 2 above and peracetic acid and chlorine dioxide solutions, prepared via dilution of the peracetic acid and chlorine dioxide compositions described in Example 9, were prepared and cooled to a temperature of 4° C. A bath containing pure water without any added antimicrobial composition was used as the control. The whole chicken carcasses were placed in the respective baths. In one trial, the carcasses were left in the baths for 60 minutes, and in another trial, the carcasses remained in the baths for 120 minutes. Active ingredient concentration and bath temperature was checked every 30 minutes and adjusted if necessary. After the respective immersion times, the samples were removed from the baths and APC and Salmonella levels determined. The results are reported in Table 11.

TABLE 11
Antimicrobial Efficacy of Immersion Treatments
vs. Water on Whole Bird Carcass

| | | |
|---|---|---|
| | APC (cfu/ml) | Salmonella (cfu/ml) |
| Treatment | log reduction | log reduction |

60 Minute Contact

| | | |
|---|---|---|
| Iodine (25 ppm) | 0.74 | 0.41 |
| Peracetic acid (25 ppm) | −0.12 | 0.50 |
| Peracetic acid (90 ppm) | 0.12 | 0.83 |
| Chlorine Dioxide (30 ppm) | 1.06 | 0.51 |

120 Minute Contact

| | | |
|---|---|---|
| Iodine (25 ppm) | 0.86 | 0.87 |
| Peracetic acid (25 ppm) | 0.36 | 0.51 |
| Peracetic acid (90 ppm) | 0.74 | 0.86 |
| Chlorine Dioxide (30 ppm) | 0.90 | 0.64 |

At 120 minute contact times, the iodine treatment exhibited results on par with high levels of peracetic acid and chlorine dioxide. Even at the shorter contact time of 60 minutes, the iodine treatment exhibited relatively high APC log reduction, and Salmonella log reductions on par with peracetic acid (25 ppm) and chlorine dioxide treatments.

### Example 11

### Efficacy of Antimicrobial Compositions on Beef Treated Via Spray Application

In this Example, the antimicrobial efficacy of compositions according to the present invention (20 and 25 ppm iodine) was compared with treatments comprising peracetic acid (100 and 200 ppm) and lactic acid (3.0 and 3.5 wt %) solutions.

Individual colonies of E. coli ATCC 10536 were grown in Tryptic Soy Broth (TSB) for 48 h at 37° C., prior to subculturing in TSB for 18 h at the same temperature. The cell density of the subculture was adjusted to ca. 10⁸ cfu/ml. Fresh beef was cut into square pieces weighing approximately 8 gr each. Each piece was inoculated with 1 ml of cell suspension resulting in a measured cell density of 5.0e+06-5.0e+07 CFU of E. coli ATCC 10536 per piece.

The antimicrobial compositions were applied to the samples using a spray bar equipped with six generally downwardly directed nozzles. The spray bar was connected to a water pump having an adjustable pressure output. The samples were placed underneath the spray bar and the spraying bar and samples were then enclosed in a plexiglass box to contain the spray to the inside of the chamber and avoid contamination on other surfaces. The samples were sprayed with the antimicrobial and control compositions for 5, 10, or 15 sec at 40 psi from a distance of 4 in from the nozzles. The treatment solutions were applied at 25° C. The concentrate from Table 1 was diluted at a dilution ratio of 1:2200 to prepare the 20 ppm iodine treatment. The 25 ppm iodine treatment is Composition 1 from Table 2, above. The peracetic acid solutions were prepared by dilution of the peracetic acid composition described in Example 9 to a peracetic acid level of 200 ppm and 100 ppm respectively. The lactic acid solutions were also prepared via dilution of a stock lactic acid composition to lactic acid levels of 3 and 3.5% by weight, respectively.

After the spray application, the entire surface of the beef sample was swabbed with a sterile sample collector. Swabs were placed in a neutralizing solution to halt the activity of the chemical, maintain bacterial cell integrity and prevent further cell damage. Bacterial recovery through the swabbing technique was also assessed for inoculated beef samples that were not subject to chemical treatment.

Cell recovery from each of the treatments was calculated using the most probable number (MPN) technique. The values obtained from each treatment were compared to that obtained from inoculated beef samples that had not received any chemical treatment. The results of the trials are provided in Table 12.

TABLE 12
Antimicrobial Efficacy of Treatments
vs. Untreated Control on Beef

| | |
|---|---|
| | E. coli (cfu/ml) |
| Treatment | log reduction |

5 sec spray time

| | |
|---|---|
| Iodine (20 ppm) | 2.66 |
| Peracetic acid (200 ppm) | 1.89 |
| Lactic acid (3.5 wt %) | 4.89 |

10 sec spray time

| | |
|---|---|
| Iodine (25 ppm) | 1.85 |
| Peracetic acid (100 ppm) | 2.37 |
| Lactic acid (3 wt %) | 2.26 |

15 sec spray time

| | |
|---|---|
| Iodine (20 ppm) | 2.36 |
| Peracetic acid (200 ppm) | 2.00 |
| Lactic acid (3.5 wt %) | 5.03 |

### Example 12

### In Vitro Efficacy of Antimicrobial Compositions

In this Example, the in vitro efficacy of an iodine-containing composition according to the present invention was compared to several other antimicrobial compositions according to EN 1656 under low and high soil conditions. Antimicrobial efficacy was determined for E. coli, L. monocytogenes, and S. enterica.

According to the test procedure employed, known bacterial concentrations, ranging between 1.5-5e+7 cfu/ml, were exposed to a known concentration of an antimicrobial composition in hard water, simulating actual field conditions. The cells were prepared in a 24 hr liquid cell culture. 1 ml samples of the cell cultures were combined with 8 ml of the antimicrobial composition in the presence of 1 ml of an interfering substance. In one trial, the interfering substance comprised 0.3% bovine serum albumin (BSA), which provides a proxy for protein soils. In another trial, the interfering substance comprised 1% BSA and 1% yeast extract (YE), which provides a proxy for protein, fats, and sugars. Both soils simulate soils left on surfaces, such as those encountered on food processing surfaces, and in particular, meat and poultry surfaces. The antimicrobial compositions tested were: 20 ppm iodine solution, 100 ppm and 200 ppm peracetic acid solutions, and 3.5 wt % lactic acid solutions prepared as described in Example 11 above, and a 280 ppm HBr in water solution.

After a 15 sec contact time at 4° C., 1 ml of the test mixture was neutralized with 9 ml of a neutralizing solution to halt the activity of the antimicrobial composition. The neutralized samples were then analyzed to determine levels of the microbes and compared to starting levels and a log reduction value calculated. The results are provided in Table 13.

TABLE 13
EN 1656 In Vitro Antimicrobial Efficacy Under Low and High Soil Conditions

| | Low Soil Conditions | | | High Soil Conditions | | |
|---|---|---|---|---|---|---|
| | (0.3% BSA) | | | (1% BSA & 1% YE) | | |
| | E. coli | L. mono. | S. enterica | E. coli | L. mono. | S. enterica |
| Iodine (20 ppm) | 5.17 | 4.36 | 5.03 | 5.00 | 3.72 | 4.75 |
| Peracetic acid | 5.00 | 4.22 | 4.72 | 4.17 | 3.22 | 4.36 |
| (100 ppm) | | | | | | |
| Peracetic acid | 6.32 | 4.41 | 6.05 | 4.05 | 3.41 | 4.22 |
| (200 ppm) | | | | | | |
| Lactic acid | 3.05 | 1.39 | 1.89 | 1.83 | 0.27 | 1.27 |
| (3.5 wt %) | | | | | | |
| HBr (280 ppm) | 5.14 | 4.36 | 5.16 | 5.00 | 3.41 | 2.6 |

In certain embodiments, the present invention can be described according to the following:

A method of treating a foodstuff so as to prevent or reduce the level of microbial contamination thereof, said method comprising:

(a) providing a foodstuff;

(b) treating said foodstuff provided in step (a) with an antimicrobial composition having an iodine content in the range of from about 1 to about 50 parts per million by weight (ppmw) based on the total weight of said composition; and

(c) processing at least a portion of said foodstuff treated in step (b) to provide at least one edible food product.

The method of paragraph [0073], wherein said iodine content of said antimicrobial composition is in the range of from about 5 to about 25 ppmw.

The method of paragraphs [0073] or [0074], wherein said treating of step (b) is effective to reduce the level of microbial contamination of said foodstuff provided in step (a) by at least 1 log.

The method of any of paragraph [0073] to [0075], wherein said treating of step (b) comprises two or more treatment stages, wherein each of said treatment stages is effective to reduce the level of microbial contamination of said foodstuff being treated by at least 0.5 log.

The method of any of paragraphs [0073] to [0076], wherein said antimicrobial composition further comprises at least one of glycerin and one or more non-ionic surfactants.

The method of any of paragraphs [0073] to [0077], wherein said antimicrobial composition further comprises at least one source of solubilizing halide ions.

The method of any of paragraphs [0073] to [0078], wherein said antimicrobial composition comprises a diluted antimicrobial concentrate, wherein said antimicrobial concentrate comprises in the range of from about 20 to about 70 weight percent of glycerin, a non-ionic surfactant, or combination thereof.

The method of any of paragraphs [0073] to [0079], wherein said antimicrobial concentrate comprises in the range of from about 2 to about 15 weight percent of a solubilizing halide ion.

The method of any of paragraphs [0073] to [0080], wherein step (b) does not substantially adversely affect the organoleptic characteristics of the treated foodstuff.

The method of any of paragraphs [0073] to [0081], wherein step (b) is carried out for a time period in the range of from about 1 to about 30 seconds.

The method of any of paragraphs [0073] to [0082], wherein during step (b) at least 85 percent of the total surface area of said foodstuff is contacted with said antimicrobial composition for at least 3 seconds.

The method of any of paragraphs [0073] to [0083], wherein step (b) includes spraying at least a portion of one surface of said foodstuff with said antimicrobial composition.

The method of any of paragraphs [0073] to [0084], wherein the total weight gained by said foodstuff during step (b) is less than 0.049 weight percent.

The method of any of paragraphs [0073] to [0085], wherein step (b) comprises at least partially immersing said foodstuff into a solution comprising said antimicrobial composition.

The method of paragraph [0086], wherein said foodstuff is transported from a first location to a second location during at least a portion of said immersing.

The method of any of paragraphs [0073] to [0087], wherein step (b) comprises both spraying said foodstuff with said antimicrobial composition and at least partially immersing said foodstuff in a solution comprising said antimicrobial composition.

The method of any of paragraphs [0073] to [0088], wherein said foodstuff provided in step (a) is an animal carcass or portion thereof.

The method of any of paragraphs [0073] to [0089], wherein said foodstuff comprises meat, poultry, fish, or seafood.

The method of any of paragraphs [0073] to [0088], wherein said foodstuff comprises fruits or vegetables.

A method for preventing or reducing the level of microbial contamination of meat during processing, said method comprising:

(a) providing at least a portion of an animal carcass;

(b) applying an iodine-containing antimicrobial composition to said animal carcass to thereby provide a treated carcass portion, wherein said iodine is the primary active biocidal agent of said antimicrobial composition; and

(c) processing at least a portion of said treated carcass portion to thereby provide at least one edible meat product.

The method of paragraph [0092], wherein step (b) is effective to reduce the level of microbial contamination of said carcass by at least 1 log.

The method of paragraphs [0092] or [0093], wherein step (b) comprises two or more separate application stages, wherein each of said stages is operable to reduce the level of microbial contamination of said carcass by at least 0.5 log.

The method of any of paragraphs [0092] to [0094], wherein said antimicrobial composition has an iodine content in the range of from about 1 to about 50 parts per million by weight (ppmw).

The method of any of paragraphs [0092] to [0095], wherein said iodine content of said antimicrobial composition is less than 25 ppmw.

The method of any of paragraphs [0092] to [0096], wherein said antimicrobial composition further comprises at least one of glycerin, at least one non-ionic surfactant, and at least one source of solubilizing halide ions.

The method of any of paragraphs [0092] to [0097], wherein said antimicrobial composition comprises a diluted antimicrobial concentrate, wherein said antimicrobial concentrate comprises in the range of from about 20 to about 70 weight percent of glycerin, a non-ionic surfactant, or combination thereof.

The method of any of paragraphs [0092] to [0098], wherein said antimicrobial composition comprises a diluted antimicrobial concentrate, wherein said antimicrobial concentrate comprises in the range of from about 2 to about 15 weight percent of a solubilizing halide ion.

The method of any of paragraphs [0092] to [0099], wherein said edible meat product exhibits substantially no adverse organoleptic effects.

The method of any of paragraphs [0092] to [0100], wherein step (b) comprises at least one of immersing and flume transport.

The method of any of paragraphs [0092] to [0101], wherein step (b) comprises at least one of spraying, misting, fogging, steaming, and combinations thereof.

The method of any of paragraphs [0092] to [0102], wherein during step (b) said carcass has a weight percent gain of less than 0.049 weight percent.

The method of any of paragraphs [0092] to [0104], wherein step (a) includes at least one of stunning, slaughtering, bleeding, dehairing, dehiding, defeathering, eviscerating, cutting, chopping, grinding, trimming, cooking, and combinations thereof.

The method of any of paragraphs [0092] to [0104], wherein said animal carcass comprises meat selected from the group consisting of beef, pork, mutton, goat meat, venison, bison, chicken, turkey, duck, fish, or seafood.

The method of any of paragraphs [0092] to [0105], wherein said animal carcass comprises meat selected from the group consisting of beef, pork, mutton, venison, bison, and goat meat.

The method of any of paragraphs [0092] to [0105], wherein said animal carcass comprises meat selected from the group consisting of chicken, turkey, or duck.

A method for preventing or reducing the level of microbial contamination of produce during processing, said method comprising:

a. providing one or more produce items to be processed;

b. transporting said produce items to a processing zone; and

c. during at least a portion of said transporting of step (b), contacting said produce items with an iodine-containing antimicrobial spray having an iodine content in the range of from about 1 to about 50 parts per million by weight (ppmw) to thereby provide one or more treated produce items; and

d. processing at least a portion of said treated produce items to thereby provide at least one edible produce item.

The method of paragraph [0108], wherein at least a portion of step (b) is carried out using a flume water transport system.

The method of paragraph [0109], wherein said flume water system comprises at least one flume having an iodine content in the range of from about 1 ppmw to about 10 ppmw.

The method of paragraph [0110], wherein said transporting step is carried out for a total contact time of said produce items with the at least one flume in the range of from about 30 seconds to about 10 minutes, wherein the temperature of said at least one flume is in the range of from about 40° F. to about 95° F.

The method of paragraphs [0108] to [0111], wherein step (c) comprises spraying said produce items with an antimicrobial wash having an iodine content in the range of from about 10 ppmw to about 50 ppmw.

The method of paragraph [0112], wherein said spraying is carried out for a contact time in the range of from about 30 seconds to about 5 minutes, wherein said antimicrobial wash has a temperature in the range of from about 35° F. to about 75° F.

The method of any of paragraphs [0108] to [0113], wherein step (c) is effective to reduce the level of microbial contamination of said produce items by at least 0.5 log.

1. A method of treating a foodstuff so as to prevent or reduce the level of microbial contamination thereof, said method comprising:
(a) providing a foodstuff;
(b) treating said foodstuff provided in step (a) with a liquid antimicrobial composition having an iodine content in the range of from about 1 to about 50 parts per million by weight (ppmw) based on the total weight of said composition said antimicrobial composition further comprising at least one iodine solubilizing agent selected from the group consisting of glycerin and alkylphenol ethoxylates, alcohol alkoxylates, polyalkylene glycol ethers, polyoxyethylene sorbitan monolaurate and monopalmitate, and polyethoxylated polyoxypropylenes; and
(c) processing at least a portion of said foodstuff treated in step (b) to provide at least one edible food product.

2. (canceled)

3. The method of claim 1, wherein said treating of step (b) is effective to reduce the level of microbial contamination of said foodstuff provided in step (a) by at least 1 log.

4. (canceled)

5. (canceled)

6. The method of claim 1, wherein said antimicrobial composition further comprises at least one source of solubilizing halide ions.

7. The method of claim 1, wherein said method further comprises the step of preparing said antimicrobial composition by diluting an antimicrobial concentrate with a diluent, wherein said antimicrobial concentrate comprises in the range of from about 20 to about 70 weight percent of said iodine solubilizing agent, and in the range of from about 0.5 to about 60 weight percent of iodine.

8. (canceled)

9. The method of claim 1, wherein step (b) does not substantially adversely affect the organoleptic characteristics of the treated foodstuff.

10. The method of claim 1, wherein step (b) is carried out for a time period in the range of from about 1 to about 30 seconds.

11. (canceled)

12. (canceled)

13. The method of claim 1, wherein the total weight gained by said foodstuff during step (b) is less than 0.049 weight percent.

14. (canceled)

15. (canceled)

16. The method of claim 1, wherein step (b) comprises both spraying said foodstuff with said antimicrobial composition and at least partially immersing said foodstuff in a solution comprising said antimicrobial composition.

17. (canceled)

18. (canceled)

19. (canceled)

20. A method for preventing or reducing the level of microbial contamination of meat during processing, said method comprising:
(a) providing at least a portion of an animal carcass;
(b) applying an iodine-containing antimicrobial composition to said animal carcass to thereby provide a treated carcass portion, wherein said iodine is the primary active biocidal agent of said antimicrobial composition, said antimicrobial composition further comprising at least one iodine solubilizing agent selected from the group consisting of glycerin and non-ionic surfactants; and
(c) processing at least a portion of said treated carcass portion to thereby provide at least one edible meat product.

21. The method of claim 20, wherein step (b) is effective to reduce the level of microbial contamination of said carcass by at least 1 log.

22. (canceled)

23. The method of claim 20, wherein said antimicrobial composition has an iodine content in the range of from about 1 to about 50 parts per million by weight (ppmw).

24. (canceled)

25. The method of claim 20, wherein said antimicrobial composition further comprises at least one source of solubilizing halide ions.

26. The method of claim 20, wherein said method further comprises the step of preparing said antimicrobial composition by diluting an antimicrobial concentrate with a diluent, wherein said antimicrobial concentrate comprises in the range of from about 20 to about 70 weight percent of said iodine solubilizing agent, and in the range of from about 0.5 to about 60 weight percent of iodine.

27. (canceled)

28. The method of claim 20, wherein said edible meat product exhibits substantially no adverse organoleptic effects.

29. The method of claim 20, wherein step (b) comprises at least one of immersing and flume transport.

30. The method of claim 20, wherein step (b) comprises at least one of spraying, misting, fogging, steaming, and combinations thereof.

31. The method of claim 20, wherein during step (b) said carcass has a weight percent gain of less than 0.049 weight percent.

32. The method of claim 20, wherein step (a) includes at least one of stunning, slaughtering, bleeding, dehairing, dehiding, defeathering, eviscerating, cutting, chopping, grinding, trimming, cooking, and combinations thereof.

33. (canceled)

34. (canceled)

35. (canceled)

36. A method for preventing or reducing the level of microbial contamination of produce during processing, said method comprising:
(a) providing one or more produce items to be processed;
(b) transporting said produce items to a processing zone; and
(c) during at least a portion of said transporting of step (b), contacting said produce items with an iodine-containing antimicrobial spray having an iodine content in the range of from about 1 to about 50 parts per million by weight (ppmw) to thereby provide one or more treated produce items, said antimicrobial composition further comprising at least one iodine solubilizing agent selected from the group consisting of glycerin and non-ionic surfactants; and
(d) processing at least a portion of said treated produce items to thereby provide at least one edible produce item.

37. The method of claim 36, wherein at least a portion of step (b) is carried out using a flume water transport system

38. (canceled)

39. The method of claim 37, wherein said transporting step is carried out for a total contact time of said produce items with the at least one flume in the range of from about 30 seconds to about 10 minutes, wherein the temperature of said at least one flume is in the range of from about 40° F. to about 95° F.

40. The method of claim 36, wherein step (c) comprises spraying said produce items with an antimicrobial wash having an iodine content in the range of from about 10 ppmw to about 50 ppmw, wherein said spraying is carried out for a contact time in the range of from about 30 seconds to about 5 minutes, wherein said antimicrobial wash has a temperature in the range of from about 35° F. to about 75° F.

41. (canceled)

42. The method of claim 36, wherein step (c) is effective to reduce the level of microbial contamination of said produce items by at least 0.5 log.
